(19) United States
(12) Patent Application Publication
(10) Pub. No.: US 2026/0024713 A1
(43) Pub. Date: Jan. 22, 2026

(54) Switching device for an electrical apparatus

(71) Applicant: Schneider Electric Industries SAS, Rueil Malmaison (FR)

(72) Inventors: Florian BEAUP, SAINT MARTIN D'URIAGE (FR); Romain MALADEN, MONESTIER DE CLERMONT (FR); Mathieu THIBAULT, LE SAPPEY EN CHARTREUSE (FR)

(21) Appl. No.: 19/269,667

(22) Filed: Jul. 15, 2025

(30) Foreign Application Priority Data
Jul. 16, 2024 (FR) FR2407808

(51) Int. Cl. H01H 33/666

(52) U.S. Cl. CPC H01H 33/666

(57) ABSTRACT

A switching device (50) for an electrical apparatus (100) is proposed, comprising:
a vacuum interrupter (3);
a drive element (4) connected to the vacuum interrupter (3);
a movable element (20) movable between a position for closing an electrical circuit and a position for opening the circuit, and comprising:
   an electrically conducting blade (11);
   a support (12) secured to the blade (11);
the movable element (20) being configured to:
   according to an opening stroke of the circuit, drive the drive element (4) via the conducting blade (11); and
   according to a closing stroke, drive the drive element (4) via the support (12).

The support (12) comprises a drive surface (14) in contact with a receiving surface (7) of the drive element (4) during a closing stroke of the circuit.

The drive surface (14) of the support (12) and the receiving surface (7) of the drive element (4) are convex in shape.

### TECHNICAL FIELD

The present invention relates to the field of switching devices for medium voltage electrical apparatuses, i.e. from 1 to 52 kV. These switching devices make it possible to cut off or establish the circulation of current in an electrical network of the medium voltage type.

### PRIOR ART

The switches which are used in electrical networks of the medium voltage type can comprise a fixed contact and a contact which is movable in rotation between at least two positions. One of the positions corresponds to a so-called closing position, in which the fixed contact and the movable contact are in mechanical and electrical contact, thus permitting circulation of the electrical current in the circuit. Another position, known as the opening position, corresponds to a position of separation of the fixed contact and the movable contact, in which the current is interrupted.

Some switches comprise three positions, with the third position of the movable contact corresponding to earthing of a portion of circuit.

The movable contact can be displaced alternately from one position to another position, by means of a control mechanism which provides it with kinetic energy. A switch of this type is positioned on each of the phases of the electrical network.

During the passage from the closing position of the electrical circuit to the opening position of the electrical circuit, during its stroke, the movable contact of the switch actuates a drive element connected to a movable electrode of a vacuum interrupter, such as to permit cut-off of the electrical current in the vacuum interrupter, and thus prevent the formation of an electrical arc at the movable contact.

During the inverse passage from the opening position to the closing position of the electrical circuit, the movable contact comes into contact with this drive element of the movable electrode, and displaces it, without however actuating the vacuum interrupter thanks to a subsystem principle which can retract in this direction of displacement of the movable contact. This interference between the movable contact and the retractable subsystem tends to reduce the speed of the movable contact, since part of the kinetic energy of the movable contact is communicated to this retractable drive subsystem of the movable electrode of the vacuum interrupter. Slowing down of this type can be problematic for obtaining certain electrical performances, such as closing under short-circuit.

There is a need to have switches which are slowed down less by the interference of the movable contact with the drive element of the vacuum interrupter, and make it possible to ensure closing of the electrical circuit in a reduced period of time.

### SUMMARY

For this purpose, the invention proposes a switching device for an electrical apparatus, the switching device comprising:
a vacuum interrupter comprising a first electrode and a second electrode which can be displaced between a closing position and an opening position;
a drive element mechanically connected to the second electrode;
a movable element which can be displaced between a first position permitting passage of electrical current in a main electrical circuit of the electrical apparatus, and a second position which prevents the passage of electrical current in the main electrical circuit;
the movable element comprising:
   an electrically conducting blade;
   an insulating support secured to the electrically conducting blade,
wherein the movable element is configured to:
   according to a first direction of displacement corresponding to a passage from the first position to the second position, drive the drive element of the movable electrode via the conducting blade; and
   according to a second direction of displacement, opposite the first direction of displacement, and corresponding to a passage from the second position to the first position, drive the drive element of the movable electrode via the support,
wherein the support comprises a drive surface configured to be in contact with a receiving surface of the drive element during passage of the movable element from the second position to the first position,
and wherein:
   the drive surface of the support has a curved shape; and
   the receiving surface of the drive element has a curved shape.

The shape of the drive surface of the support as well as the shape of the receiving surface of the drive element make it possible to minimise the loss of kinetic energy sustained by the movable element, and therefore prevents excessive slowing down of the movable element during the closing stroke of the main circuit. The performance of the switching device, in particular the closing under short-circuit, is improved.

It is not necessary to increase the energy of the control mechanism. An increase of this type can have limited efficiency for the closing phases, and have negative effects on other operating phases, such as the operations of opening, or earthing. It is thus particularly advantageous to be able to increase the speed of the movable contact during the closing phase of the circuit without having to modify the mechanism which displaces the movable element bearing the conducting blade.

The characteristics listed in the following paragraphs can be implemented independently from one another, or according to all the technically possible combinations:

The drive surface of the support delimits a convex portion.

The receiving surface of the drive element delimits a convex portion.

According to an embodiment of the switching device, the drive surface of the support and the receiving surface of the drive element are formed such that a mechanical contact between the drive surface of the support and the receiving surface of the drive element is a linear contact.

This type of contact between the support and the drive element makes it possible to optimise the forces between the parts, and the distribution of the friction between these parts, and thus reduce the loss of speed of the movable element during the closing of the main circuit.

According to an embodiment of the switching device, the movable element is movable in rotation around an axis of rotation,
the support extends parallel to the conducting blade, with a portion of the support forming a drive surface being positioned projecting from the blade, and
a line of contact between the drive surface of the support and the receiving surface of the drive element extends in a direction parallel to the axis of rotation of the movable element.

Part of the support is positioned projecting from the blade in a direction perpendicular to a main axis of extension of the blade, and perpendicular to the axis of rotation of the movable element.

The support is facing the conducting blade in a direction parallel to the axis of rotation of the movable element.

According to an embodiment of the switching device, the drive element comprises a first arm and a second arm which can pivot in relation to the first arm along an axis of pivoting; and
the first arm comprises a stop which is configured to block pivoting of the second arm in relation to the first arm in a first direction of rotation corresponding to passage of the movable element from the first position to the second position, such that the movable element drives the first arm via the second arm;
the second arm can pivot in relation to the first arm in a second direction of rotation corresponding to passage of the movable element from the second position to the first position;
and the receiving surface of the drive element is formed on the second arm.

According to a first direction of thrust applied to the second arm, corresponding to passage from the first position to the second position, the first arm and the second arm are rigidly connected to one another.

According to a second direction of thrust applied to the second arm, corresponding to passage from the second position to the first position, the first arm and the second arm are connected in translation, and free in rotation in relation to one another.

According to an embodiment of the switching device, a distance between the line of contact of the drive surface of the support with the receiving surface of the drive element and the axis of pivoting of the second arm depends on an angular position of the movable element, and decreases in a monotonic manner as the angular position of the movable element approaches the first position.

This geometry allows the movable element to have a drive principle which is favourable to reduction of the quantity of energy absorbed by the second arm in order to move aside at the passage of the movable element.

According to an embodiment of the switching device, the position of a line of contact between the drive surface of the support and the receiving surface of the drive element is displaced, during passage of the movable element from the second position to the first position, along the drive surface of the support, in a single direction of displacement. The single direction of displacement corresponds to a decrease in the distance between the line of contact and the axis of pivoting of the second arm.

A position along the drive surface of the line of contact between the drive surface of the support and the receiving surface depends on an angular position of the movable element, and varies in a monotonic manner according to the angular position of the movable element.

A position along the receiving surface of the drive element of the line of contact between the drive surface of the support and the receiving surface depends on an angular position of the movable element, and varies in a monotonic manner according to the angular position of the movable element.

According to an aspect of the switching device, the drive surface of the support extends between:
a first end forming an area of establishment of mechanical contact with the receiving surface of the drive element; and
a second end forming an area of loss of contact with the receiving surface of the drive element.

The area of establishment of mechanical contact corresponds to the portion of the support which comes into contact with the receiving surface of the drive element, during passage of the movable element from the second position to the first position.

The area of loss of contact corresponds to the portion of the support which ceases to be in contact with the receiving surface of the drive element during passage of the movable element from the second position to the first position.

According to an aspect of the switching device, the receiving surface of the drive element extends between:
a first end forming an area of establishment of mechanical contact with the support; and
a second end forming an area of loss of contact with the support.

The area of establishment of mechanical contact with the support corresponds to the portion of the drive element which comes into contact with the drive surface of the support during passage from the second position to the first position.

The area of loss of mechanical contact of the receiving surface of the drive element corresponds to the portion of the drive element which ceases to be in contact with the drive surface of the support during passage from the second position to the first position.

According to an aspect of the switching device, the first end of the receiving surface of the drive element is further away from the axis of pivoting of the second arm than the second end of the receiving surface of the drive element which forms a final area of contact.

According to an embodiment of the switching device, the first end of the receiving surface of the drive element, forming an area of establishment of mechanical contact with the support, is facing an edge of the second arm.

This arrangement of the line of contact where the mechanical contact is established between the moving parts, makes it possible to maximise the torque applied to the second arm by the movable element during the initial impact between the parts. The acceleration of the second arm can thus take place while minimising the loss of kinetic energy of the movable element during its displacement stroke.

The second arm of the drive element has a generally parallelepiped shape, and the first end of the receiving surface of the second arm of the drive element, forming an initial area of contact, is in the vicinity of a ridge opposite the axis of pivoting.

According to an embodiment of the switching device, a profile of the drive surface of the support and a profile of the receiving surface of the drive element are configured to orient a thrust force of the drive surface onto the second arm of the drive element, in a direction substantially perpendicular to a direction tangent to the second arm and the drive element.

According to an embodiment of the switching device, the second arm of the drive element extends along a main axis, and a drive force exerted by the support on the second arm of the drive element is oriented in a direction forming an angle of between 70° and 90° with the main axis of extension of the second arm of the drive element.

The torque which is applied to the second arm by the support during the displacement stroke of the movable element is thus maximised.

According to an embodiment of the switching device, a profile of the drive surface of the support, seen in a direction parallel to the axis of pivoting of the second arm, comprises a first portion in the form of an arc of a circle, extended by a second portion in the form of an arc of a circle.

According to an embodiment of the switching device, the first portion of the profile of the drive surface of the support, and the second portion of the profile of the drive surface of the support are tangent at a point of connection of the first portion to the second portion.

This geometry contributes towards minimising the quantity of energy necessary to obtain the retraction of the second arm, while being simple to produce.

According to an embodiment of the switching device, a radius of the first portion of the profile of the drive surface of the support is between 8 and 16 mm, preferably between 10 mm and 14 mm, and more preferably between 11 mm and 13 mm.

According to an embodiment of the switching device, the first portion of the profile of the drive surface of the support extends over an angular sector with a value of between 5° and 45°.

This geometry contributes towards obtaining sufficient acceleration of the second arm, while being simple to produce.

According to an embodiment of the switching device, a radius of the second portion of the profile of the drive surface of the support is between 24 and 40 mm, preferably between 28 mm and 36 mm, and more preferably between 31 mm and 33 mm.

According to an embodiment of the switching device, the second portion of the profile of the drive surface of the support extends over an angular sector with an angular value of between 30° and 90°.

As previously, this geometry contributes towards minimising the quantity of energy necessary in order to obtain the retraction of the second arm, while being simple to produce.

According to an embodiment of the switching device, the first end of the drive surface of the support, forming an area of establishment of mechanical contact with the receiving surface of the drive element, forms part of the first portion in the form of an arc of a circle.

According to an embodiment of the switching device, the second end of the drive surface of the support, forming an area of loss of contact with the receiving surface of the drive element, forms part of the second portion in the form of an arc of a circle.

According to an embodiment of the switching device, a profile of the receiving surface of the drive element, seen in a direction parallel to the axis of rotation of the second arm, comprises a first portion in the form of an arc of a circle, extended by a second portion in the form of an arc of a circle.

According to an embodiment, the second portion of the profile of the receiving surface of the drive element and the first portion of the profile of the receiving surface of the drive element are tangent at a first point of connection of the second portion to the first portion.

As previously, this geometry makes it possible to minimise the quantity of energy, allowing the second arm to retract at the passage of the movable element.

According to an embodiment, a radius of the first portion of the profile of the receiving surface of the drive element is between 6 and 14 mm, preferably between 8 mm and 12 mm, more preferably between 9 mm and 11 mm.

According to an embodiment, the first portion of the profile of the receiving surface of the drive element extends over an angular sector with an angular value of between 20° and 30°, preferably between 24° and 28°.

According to an embodiment, the second portion of the profile of the receiving surface of the drive element extends over an angular sector with an angular value of between 7° and 9°.

According to an embodiment, the radius of the second portion of the profile of the receiving surface of the drive element is between 60 mm and 100 mm, preferably between 70 mm and 90 mm, and more preferably between 78 mm and 82 mm.

According to an embodiment of the switching device, the profile of the receiving surface of the drive element, seen in a direction parallel to the axis of rotation of the second arm, comprises a third portion with a straight form, extending the second portion in the form of an arc of a circle.

The third portion of the profile of the receiving surface of the drive element and the second portion of the profile of the receiving surface of the drive element are tangent at a second point of connection of the third portion to the second portion.

According to an embodiment, the second portion of the profile of the receiving surface of the drive element extends over an angular sector of between 55° and 70°, preferably between 60° and 64°.

According to an embodiment of the switching device, the first end of the receiving surface of the drive element, forming an initial area of contact, forms part of the first portion in the form of an arc of a circle of the drive element.

According to an embodiment, the second end of the receiving surface of the drive element, forming a final area of contact, forms part of the third portion with a straight form of the drive element.

According to an embodiment of the switching device, the profile of the receiving surface of the drive element, seen in a direction parallel to the axis of rotation of the second arm, comprises a fourth portion in the form of an arc of a circle, extending the third portion with a straight form.

According to an embodiment of the switching device:
the movable element comprises a first conducting blade and a second conducting blade, with the first conducting blade and the second conducting blade extending facing one another in a direction parallel to an axis of rotation of the movable element;
the support comprises a first drive surface and a second drive surface, each drive surface being configured to be in contact with the receiving surface of the drive element during passage from the second position to the first position,
the first drive surface and the second drive surface being positioned on both sides of the movable element.

A fixed contact can come into contact with each of the conducting blades of the movable element.

The invention also relates to a medium voltage electrical apparatus, which is configured selectively to establish or cut off the current in a medium voltage electrical network comprising three phases, comprising an electrical current switching device as previously described, positioned respectively on each of the phases of the electrical network.

The electrical apparatus can be a power disconnector, or a circuit breaker.

### BRIEF DESCRIPTION OF THE DRAWINGS

Other characteristics, details and advantages will become apparent from reading the following detailed description, and from analysing the appended drawings, in which:

FIG. 1 is a view of an electrical apparatus incorporating a switching system according to the invention;

FIG. 2 is a schematic representation illustrating the operation of a switching system for an electrical apparatus, in a phase of opening of an electrical circuit of the electrical apparatus;

FIG. 3 is another schematic representation illustrating the operation of a switching system for an electrical apparatus, in a phase of opening of an electrical circuit of the electrical apparatus;

FIG. 4 is a schematic representation illustrating the operation of the switching system of FIG. 3, in a phase of closing of the electrical circuit of the electrical apparatus;

FIG. 5 is a view of the switching system of FIG. 1, in a first phase of closing of an electrical circuit of the electrical apparatus;

FIG. 6 is a view of the switching system of FIG. 1, in a second phase of closing of the electrical circuit of the electrical apparatus;

FIG. 7 is a detail view of the switching system of FIG. 5;

FIG. 8 is a detail view of a support incorporated in the switching system of FIGS. 5 to 7;

FIG. 9 is a detail view of a drive element incorporated in the switching system of FIGS. 5 to 7.

### Description of some embodiments

In order to facilitate reading of the figures, the different elements are not necessarily represented to scale. In these figures, identical elements bear the same references. Certain elements or parameters can be indexed, i.e. designated for example as the first element or second element, or also first parameter and second parameter, etc. This indexing serves the purpose of differentiating elements or parameters which are similar, but not identical. This indexing does not imply priority of one element or parameter in relation to another, and the denominations can be interchanged. When it is specified that a device comprises a given element, that does not exclude the presence of other elements in this device.

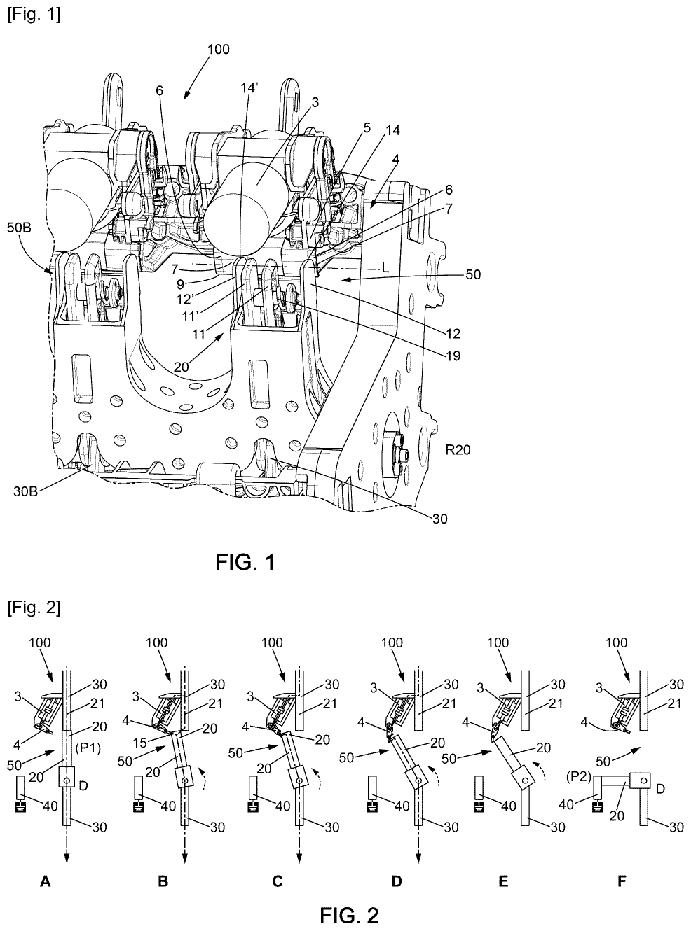

FIG. 1 represents a medium voltage electrical apparatus 100. The electrical apparatus 100 is configured selectively to establish or cut off the current in a medium voltage electrical network comprising three phases. The electrical network 100 comprises an electrical current switching device positioned respectively on each of the phases of the electrical network.

The reference 50 designates the switching device equipping a first phase, and the reference 50B designates the one equipping a second phase. The switching device which equips the third phase, not represented, is positioned adjacent to the device 50B.

In the example of FIG. 1, the electrical apparatus 100 is a power disconnector. According to another example of an application, not represented, the electrical apparatus 100 can be a circuit breaker.

The electrical apparatus 100 comprises a main circuit 30 in which an electrical current can circulate. The main circuit 30 corresponds to one of the phases of the electrical apparatus 100. The switching system 50 makes it possible selectively to cut off the passage of current in the main circuit 30, or permit the passage of the current in the main circuit 30. The switching system 50 comprises a movable element 20, which is movable in rotation according to an axis of rotation R20.

The movable element 20 comprises a first conducting blade 11 and a second conducting blade 11′. The first conducting blade 11 and the second conducting blade 11′ extend facing one another in a direction parallel to the axis of rotation R20 of the movable element 20.

A fixed contact 21 of the main circuit 30, not represented in FIG. 1, can come into contact with each of the conducting blades 11, 11′ of the movable element 20.

The two electrically conducting blades 11, 11′ are connected mechanically in rotation, and are offset in relation to one another along a common axis of rotation R20.

The two blades 11, 11′ are in contact with each of the blades 11, 11′ when the movable element 20 is in the closing position of the main electrical circuit 30. The fixed contact 21, not represented in FIG. 1, is thus positioned between the blades 11, 11′, and a spring 19 makes it possible to ensure contact pressure between the blades 11, 11′ and the fixed contact 21.

FIG. 2 describes schematically the successive steps of an operation of cutting off the current in the main circuit 30.

The parts designated by the references A to F are in chronological order. The broken lines which end in an arrow schematise the passage of the current.

In this case, the electrical apparatus 1 comprises an earthing contact 40. The movable element 20 is movable in rotation between a nominal position P1 of circulation of the electrical current in the main circuit 30, illustrated by the part A of FIG. 2, and a position P2 in which the movable element 20 is connected to the earthing contact 40, illustrated in the part F of the same figure. According to other embodiments, not represented, the earthing contact 40 need not be present. The position P2 can thus be a stable position of opening of the main circuit 30, without earthing.

A control mechanism, not represented, can displace the movable element 20 alternately from the position P1 to the position P2. The control mechanism comprises a set of springs maintained under tension by locking elements, which can be released such as to trigger displacement from the position P1 to the position P2. In the same manner, the control mechanism allows the movable element 20 to pass from the position P2 to the position P1 under the action of a set of springs. The potential energy of these springs is converted into kinetic energy of the movable element 20.

In the part B of FIG. 2, the movable element 20 has initiated a movement of rotation in an anticlockwise direction of rotation according to FIG. 2, and begins to be released from the fixed contact 21. During its rotation, the movable element 20 will come into contact with, and displace, a drive element 4 which is connected to a movable electrode of a vacuum interrupter 3. The displacement of the drive element 4 thus makes it possible to separate the electrodes 1, 2 from the vacuum interrupter 3. In the part B of FIG. 2, an electrical contact between the movable element 20 and the fixed contact 21 is still established, because of the width of the areas in contact. An electrical contact between the movable element 20 and the vacuum interrupter 3 is also created. The movable element 20 is in contact with the drive element 4. An electrical current circulates simultaneously in the fixed contact 21, and in parallel in the vacuum interrupter 3.

In the part C, the movable element 20 has continued its movement of rotation, and is no longer in contact with the fixed contact 21. The movable element 20 has started to displace the drive element 4. The vacuum interrupter 3 is closed, i.e. its electrodes are in contact. All the current passes via the vacuum interrupter 3, and no current passes via the fixed contact 1.

In the part D, the movable element 20 has displaced further the drive element 4, which has triggered the opening of the vacuum interrupter 3. The electrodes of the vacuum interrupter 3 have thus started to separate from one another. The current passes into the vacuum interrupter 3 in the form of an electrical arc, when the contact opens.

In the part E, the drive element 4 has continued to be driven by the movable element 20, and the spacing between the electrodes 1, 2 of the vacuum interrupter 3 is maximal. Shortly after the passage through zero of the phase current, the current in the vacuum interrupter 3 is cut off. The current in the main circuit 30 is thus cut off.

In the part F, the movable element 20 has completed its movement of rotation, and is in contact with the earthing contact 40. A resilient return element, not represented, has returned the drive element 4 to the position corresponding to closing of the vacuum interrupter 3.

During an inverse operation of establishment of the current in the main circuit 30, the movable element 20 rotates in the inverse direction, i.e. in the clockwise direction on the diagram of FIG. 2.

The switching device 50 for an electrical apparatus 100, proposed within the context of the invention, will now be described in detail.

The switching device 50 comprises:
a vacuum interrupter 3 comprising a first electrode 1 and a second electrode 2 which can be displaced between a closing position F and an opening position O;
a drive element 4 which is connected mechanically to the second electrode 2;
a movable element 20 which can be displaced between a first position P1 permitting passage of electrical current in a main electrical circuit of the electrical apparatus 100, and a second position P2 preventing the passage of electrical current in the main electrical circuit.

The movable element 20 comprises:
an electrically conducting blade 11;
an insulating support 12 which is integral with the electrically conducting blade 11.

The movable element 20 is configured to:
in a first direction of displacement S1, corresponding to passage from the first position P1 to the second position P2, drive the drive element 4 of the movable electrode 3 by means of the conducting blade 11; and
in a second direction of displacement S2, opposite the first direction of displacement S1, and corresponding to passage from the second position P2 to the first position P1, drive the drive element 4 of the movable electrode 3 by means of the support 12.

The support 12 comprises a drive surface 14 which is configured to be in contact with a receiving surface 7 of the drive element 4 during passage of the movable element 20 from the second position P2 to the first position P1; and
the drive surface 14 of the support 12 has a curved shape;
the receiving surface 7 of the drive element 4 has a curved shape.

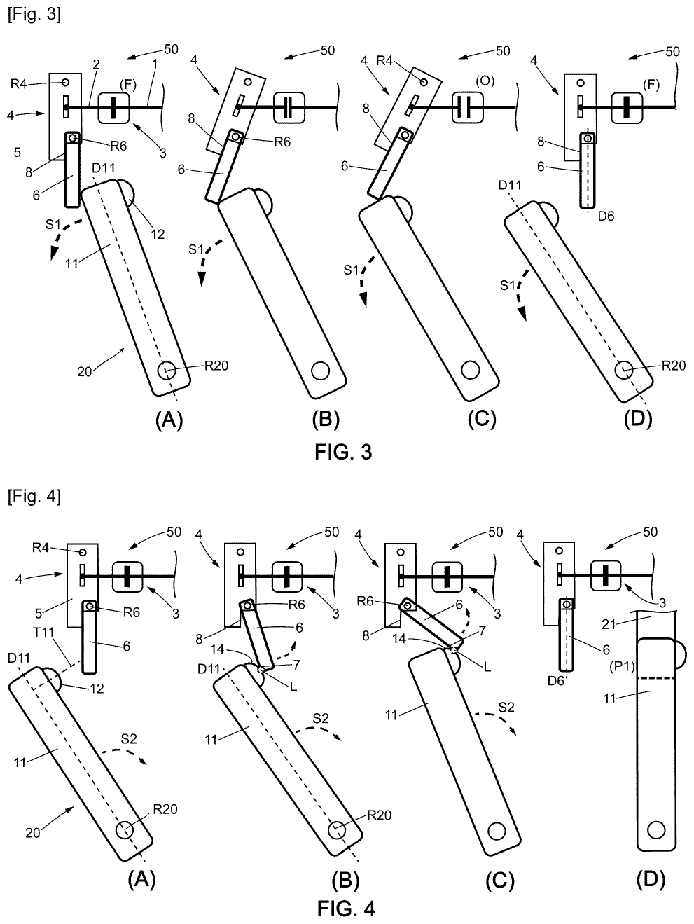

FIG. 3 illustrates part of the stroke of passage of the movable element 20 from the first position P1 to the second position P2, corresponding to driving of the drive element 4 of the movable electrode 3 by means of the conducting blade 11. The parts which are designated by the references A to D are in chronological order. During this phase of opening of the vacuum interrupter, the conducting blade 11 pivots the drive element 4, which opens the vacuum interrupter 3.

The direction of displacement of the movable assembly 20 is indicated by the reference S1, and corresponds to the anticlockwise direction in FIG. 3.

FIG. 4 illustrates part of the stroke of passage of the movable element 20 from the second position P2 to the first position P1, corresponding to driving of part of the drive element 4 by means of the support 12.

The direction of displacement of the movable assembly 20 is indicated by the reference S2, and corresponds to the clockwise direction.

In this direction of displacement S2, the support 12 projects from the conducting blade 11, and comes into contact with the drive element 4 for part of the stroke of the movable element 20. The conducting blade 11, which is withdrawn from the support 12 in this direction of displacement, remains spaced from the drive element 4 throughout the stroke of displacement of the movable element 20.

The support 12 thrusts back part of the drive element 4, without modifying the position of the contacts of the vacuum interrupter 3. This phase, which is known as the phase of retraction, will be described in detail hereinafter.

The first position P1 is known as the closing position of a main electrical circuit 30 of the electrical apparatus 100.

The second position P2 is known as the opening position of a main electrical circuit 30 of the electrical apparatus 100.

The shape of the drive surface 14 of the support 12, as well as the shape of the receiving surface 7 of the drive element 4, make it possible to minimise the loss of kinetic energy sustained by the movable element 20 by driving the drive element 4, and thus prevent excessive slowing down of the movable element 20 during its stroke of closing of the main circuit 30, schematised in FIG. 4.

The performance of the switching device 50, in particular the closing under short-circuit, is thus improved.

This improvement is obtained without modifying the control mechanism, in particular without increasing the energy of the control mechanism. An increase of this type can have limited efficiency for the closing phases, and can have negative effects on other operating phases, such as the operations of opening or earthing. It is thus particularly advantageous to be able to increase the speed of the movable contact 20 during the phase of closing of the circuit, without needing to modify the mechanism which displaces the movable element 20 that bears the conducting blade 11.

The drive surface 14 of the support 12 delimits a convex portion. Similarly, the receiving surface 7 of the drive element 4 delimits a convex portion.

The electrically conducting blade 11 is formed by a copper rod with a flattened shape.

The support 12 is made of plastic material, for example thermoplastic material, such as an engineering thermoplastic. The support 12 is electrically insulating.

The drive element 4 is electrically insulating.

The drive element 4 is made of plastic material, for example thermoplastic material, such as an engineering thermoplastic.

The drive element 4 is a drive lever. The lever is articulated at one of its ends, and can pivot around an axis of pivoting R4 under the effect of a thrust force applied by the movable element 20 during its displacement stroke.

According to the example illustrated of the switching device 50, the drive surface 14 of the support 12 and the receiving surface 7 of the drive element 4 are formed such that a mechanical contact between the drive surface 14 of the support 12 and the receiving surface 7 of the drive element 4 is a linear contact.

In other words, an area of contact between the drive surface 14 of the support 12 and the receiving surface 7 of the drive element 4 is a straight line L.

This straight line of contact L is represented in perspective in FIG. 1.

The straight line of contact L is perpendicular to the plane of FIG. 4. In order to facilitate its representation, the straight line of contact L has been represented by a circle in broken lines on part B and part C of FIG. 4, and not by a dot.

A contact of a linear, and not surface type, between the support 12 and the drive element 4 makes it possible to optimise the forces between the parts as well as the distribution of the friction between these parts. The loss of speed of the movable element 20 during the closure of the main circuit is thus reduced.

It is understood that the contact is linear when the parts have the theoretical shape by their interface plane. The inevitable resilient deformations during real contacts and impacts between the parts are not taken into account.

The drive surface 14 of the support 12 and the receiving surface 7 of the drive element 4 are configured to slide in relation to one another during passage from the second position P2 to the first position P1.

The drive surface 14 of the support 12 and the receiving surface 7 of the drive element 4 are in contact with one another on part of the stroke of displacement of the movable element 20 from the second position P2 to the first position P1.

For a given angular position of the movable element 20, the contact between the support 12 and the drive element is formed along a line of contact L. The position of this line of contact L varies according to the angular position of the movable element 20, and reference is thus made to a drive surface 14, which forms part of the support 12, and a receiving surface 7, which forms part of the drive element 4.

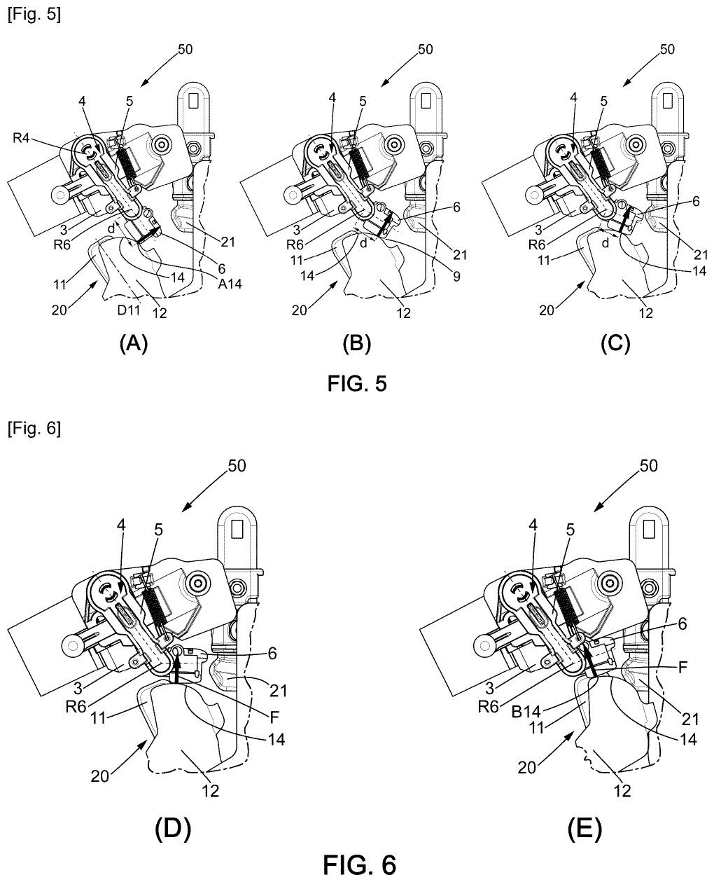

The movable element 20 is movable in rotation around an axis of rotation R20. As represented in particular in FIGS. 5 and 6, the support 12 extends parallel to the conducting blade 11. A portion of the support 12 which forms a drive surface 14 is positioned projecting from the blade 11, and a line of contact L between the drive surface 14 of the support 12 and the receiving surface 7 of the drive element 4 extends in a direction parallel to the axis of rotation R20 of the movable element 20.

Part of the support 12 is positioned projecting from the blade 11 in a direction T11 perpendicular to a main axis of extension D11 of the blade 11, and perpendicular to the axis of rotation R20 of the movable element 20.

As represented in FIG. 1, the support 12 is facing the conducting blade 11 in a direction parallel to the axis of rotation R20 of the movable element 20.

The support 12 and the blade 11 are both perpendicular to the axis of rotation R20, and are offset along the axis of rotation R20.

The spring 19 is positioned between the blade 11 and the support 12, in a direction parallel to the axis of rotation R20 of the movable element 20.

The axis of the spring 19 is parallel to the axis of rotation R20.

The drive element 4 will now be described in greater detail. As represented in particular in FIGS. 3 and 4, the drive element 4 comprises a first arm 5 and a second arm 6 which can pivot in relation to the first arm 5 along an axis of pivoting R6.

The first arm 5 comprises a stop 8, which is configured to block pivoting of the second arm 6 in relation to the first arm 5 in a first direction of rotation, corresponding to passage of the movable element 20 from the first position P1 to the second position P2, such that the movable element 20 drives the first arm 5 by means of the second arm 6.

The second arm 6 can pivot in relation to the first arm 5 in a second direction of rotation corresponding to passage of the movable element 20 from the second position P2 to the first position P1,
and the receiving surface 7 of the drive element 4 is formed on the second arm 6. The first arm 5 can pivot in relation to the axis of pivoting R4.

The axis of pivoting R4 of the first arm 5 and the axis of pivoting R6 of the second arm 6 are parallel to one another.

In a first direction of thrust applied to the second arm 6, corresponding to passage from the first position P1 to the second position P2, the first arm 5 and the second arm 6 are rigidly connected to one another.

In a second direction of thrust applied to the second arm 6, corresponding to passage from the second position P2 to the first position P1, the first arm 5 and the second arm 6 are connected in translation, and free in rotation in relation to one another.

The second arm 6 and the first arm 5 are rigidly connected when the thrust applied to the second arm 6 corresponds to passage of the movable element 20 from the first position P1 to the second position P2.

In the direction of rotation illustrated by the reference S1 in FIG. 3, the second arm 6 is supported on the stop 8, and rotation of the second arm 6 in relation to the axis of pivoting R6 formed on the first arm 5, is thus blocked. The second arm 6 and the first arm 5 are therefore rigidly connected.

In this direction of displacement of the movable element 20, the thrust of the movable element 20 on the second arm 6 is thus transmitted to the first arm 5, which pivots in relation to the axis of pivoting R6, and therefore displaces the second electrode 2 in relation to the electrode 1.

The second arm 6 can pivot in relation to the first arm 5 when the thrust applied to the second arm 6 corresponds to passage of the movable element 20 from the second position P2 to the first position P1.

In the direction of rotation illustrated by the reference S2 in FIG. 4, no part of the first arm 5 opposes rotation of the second arm 6 in relation to the axis of pivoting R6. The movable element 20 thrusts the second arm 6 back without driving the first arm 5. The second electrode 2 is therefore not displaced by the drive element 4, and the vacuum interrupter 3 remains in the closed position.

It is said that the second arm 6 is retracted at the passage of the movable element 20.

FIGS. 5 to 9 illustrate an embodiment.

As schematised in FIG. 5, the distance d between the line of contact L of the drive surface 14 of the support 12 and the receiving surface 7 of the drive element 4 and the axis of pivoting R6 of the second arm 6 depends on an angular position of the movable element 20.

This distance d between the line of contact L and the axis of pivoting R6 decreases in a monotonic manner as the angular position of the movable element 20 approaches the first position P1.

This geometry allows the movable element 20 to have a drive principle which is favourable to reduction of the quantity of energy absorbed by the second arm 6 in order to move aside at the passage of the movable element 20.

“Monotonic decrease” means that the distance d between the line of contact L and the axis of pivoting R6 decreases constantly between the phase of approach of the support 12 to the second arm 6, and the phase of end of mechanical contact between the support 12 and the second arm 6. The phase of approach is the phase of establishment of mechanical contact between the parts, and the phase of end of mechanical contact is the phase of separation of the parts.

The position of a line of contact L between the drive surface 14 of the support 12 and the receiving surface 7 of the drive element 4 is displaced, during passage of the movable element 20 from the second position P2 to the first position P1, along the drive surface 14 of the support 12, in a single direction of displacement.

The single direction of displacement corresponds to a decrease in the distance d between the line of contact L and the axis of pivoting R6 of the second arm 6.

The position along the drive surface 14 of the line of contact L between the drive surface 14 of the support 12 and the receiving surface 7 depends on the angular position of the movable element 20, and varies in a monotonic manner according to the angular position of the movable element 20.

In the same way, the position along the receiving surface 7 of the drive element 4 of the line of contact L between the drive surface 14 of the support 12 and the receiving surface 7 depends on an angular position of the movable element 20, and varies in a monotonic manner according to the angular position of the movable element 20.

The drive surface 14 of the support 12 extends between:
a first end A14 forming an area of establishment of mechanical contact with the receiving surface 7 of the drive element 4; and
a second end B14 forming an area of loss of contact with the receiving surface 7 of the drive element 4.

The area of establishment of mechanical contact corresponds to the portion of the support 12 which comes into contact with the receiving surface 7 of the drive element 4, during passage of the movable element 20 from the second position P2 to the first position P1.

The area of loss of contact corresponds to the portion of the support 12 which ceases to be in contact with the receiving surface 7 of the drive element 4, during passage of the movable element 20 from the second position P2 to the first position P1.

Similarly, the receiving surface 7 of the drive element 4 extends between:
a first end A7 forming an area of establishment of mechanical contact with the support 12; and
a second end 7 forming an area of loss of contact with the support 12.

The area of establishment of mechanical the support 12 corresponds to the portion of the drive element 4 which comes into contact with the drive surface 14 of the support 12, during passage from the second position P2 to the first position P1.

The area of loss of mechanical contact of the receiving surface 7 of the drive element 4 corresponds to the portion of the drive element 4 which ceases to be in contact with the drive surface 14 of the support 12, during passage from the second position P2 to the first position P1.

The first end A7 of the receiving surface 7 of the drive element 4 is further away from the axis of pivoting R6 of the second arm 6 than the second end B7 of the receiving surface 7 of the drive element 4 forming a final area of contact.

According to the example illustrated of the switching device 50, the first end A7 of the receiving surface 7 of the drive element 4, forming an area of establishment of mechanical contact with the support 12, is facing an edge 9 of the second arm 6.

This arrangement of the line of contact L, where the mechanical contact is established between the support 12 and the second arm 6, makes it possible to maximise the torque applied to the second arm 6 by the support 12 of the movable element 20 during the initial impact between the parts. The acceleration of the second arm 6 can thus take place while minimising the loss of kinetic energy of the movable element 20 during its displacement stroke.

The second arm 6 of the drive element 4 has a generally parallelepiped shape, and the first end A7 of the receiving surface 7 of the second arm 6 of the drive element 4, forming an initial area of contact, is in the vicinity of a ridge 9 opposite the axis of pivoting R6.

The first end A7 of the receiving surface 7 of the drive element 4 is in the vicinity of the ridge 9 of the second arm 6 which is furthest from the axis of pivoting R6 of the second arm 6. The first end A7 of the receiving surface 7 coincides substantially with the ridge of the parallelepiped which is furthest from the axis of pivoting R6.

According to the example illustrated, the profile 15 of the drive surface 14 of the support 12, and the profile 10 of the receiving surface 7 of the drive element 4, are configured to orient a thrust force F of the drive surface 14 onto the second arm 6 of the drive element 4, in a direction F substantially perpendicular to a direction T tangent to the second arm 6 and to the drive element 12.

“Profile” means the shape of the receiving surface 7, or of the drive surface 14, seen in a direction parallel to the axis of rotation of the movable assembly 20.

FIGS. 5 to 9 make it possible to visualise the profile 15.

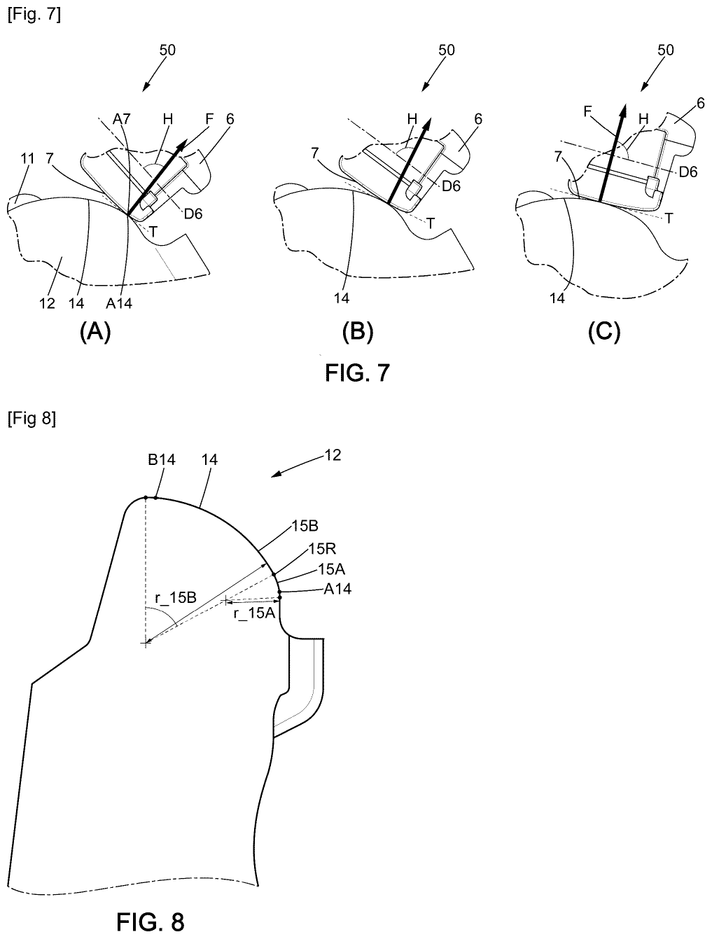

FIG. 7 illustrates the orientation of the thrust force F in relation to the tangent straight line common to the drive surface 14 and to the receiving surface 7.

The second arm 6 of the drive element 4 extends along a main axis D6, and the drive force F exerted by the support 12 on the second arm 6 of the drive element 4 is oriented in a direction forming an angle H of between 70° and 90° with the main axis of extension D6 of the second arm 6 of the drive element 4.

The torque which is applied to the second arm 6 by the support 12 during the displacement stroke of the movable element 20 is thus maximised.

FIG. 8 shows in detail the profile 15 of the drive surface 14 of the support 12.

The profile 15 of the drive surface 14 of the support 12, seen in a direction parallel to the axis of pivoting R6 of the second arm 6, comprises a first portion 15A in the form of an arc of a circle, extended by a second portion 15B in the form of an arc of a circle.

The first portion 15A of the profile of the drive surface 15 of the support 12, and the second portion 15B of the profile 15 of the drive surface 14 of the support 12, are tangent at a point of connection 15R of the first portion 15A to the second portion 15B.

This geometry contributes towards minimising the quantity of energy necessary for obtaining the retraction of the second arm 6, while being simple to produce.

According to the example illustrated, the radius r_15A of the first portion 15A of the profile 15 of the drive surface 14 of the support is between 8 and 16 mm.

The radius r_15A is preferably between 10 mm and 14 mm.

More preferably, the radius r_15A is between 11 mm and 13 mm.

The first portion 15A of the profile 15 of the drive surface 14 of the support 12 extends over an angular sector with a value of between 5° and 45°.

This geometry contributes towards obtaining sufficient acceleration of the second arm 6 while being simple to produce.

According to the example illustrated in FIG. 8, the radius r_15B of the second portion 15B of the profile 15 of the drive surface 14 of the support 12 is between 24and 40 mm.

Preferably, the radius r_15B is between 28 mm and 36 mm.

More preferably, the radius r_15B is between 31 mm and 33 mm.

The second portion 15B of the profile 15 of the drive surface 14 of the support 12 extends over an angular sector with an angular value of between 30° and 90°.

As previously, this geometry contributes towards minimising the quantity of energy necessary to obtain the retraction of the second arm 6, while being simple to produce.

The first end A14 of the drive surface 14 of the support 12, forming an area of establishment of mechanical contact with the receiving surface 7 of the drive element 4, forms part of the first portion 15A in the form of an arc of a circle.

The second end B14 of the drive surface 14 of the support 12, forming an area of loss of contact with the receiving surface 7 of the drive element 4, forms part of the second portion 15B in the form of an arc of a circle.

In other words, the initial contact between the support 12 and the drive element 14 takes place at an area of contact on the first portion 15A in the form of an arc of a circle.

The area of contact is then offset, as the rotation of the movable element 20 takes place, and in particular the rotation of the support 12.

When the support 12 and the drive element 4 separate, the area of loss of contact, in other words the final point of the profile where contact is still ensured, is a point of the second portion 15B.

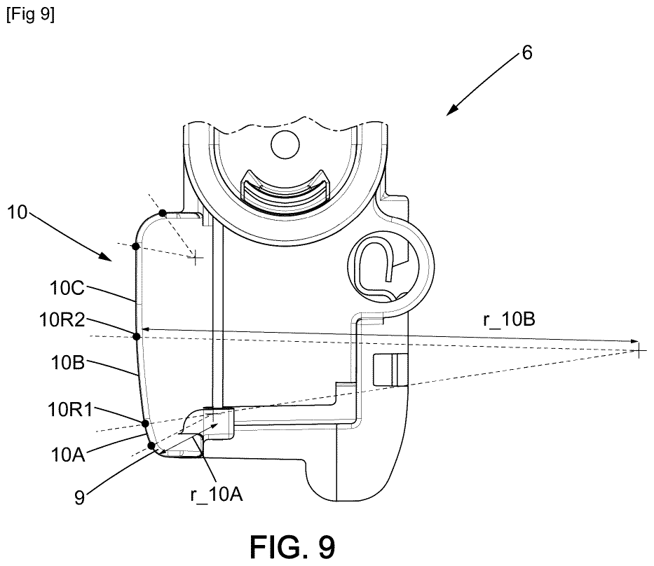

FIG. 9 shows a detail of the profile 10 of the receiving surface 7 of the drive element 4.

The profile 10 of the receiving surface 7 of the drive element 4, seen in a direction parallel to the axis of rotation R6 of the second arm 6, comprises a first portion 10A in the form of an arc of a circle, extended by a second portion 10B in the form of an arc of a circle.

The second portion 10B of the profile 10 of the receiving surface 7 of the drive element 4, and the first portion 10A of the profile 10 of the receiving surface 7 of the drive element 4 are tangent at a first point of connection 10R1 of the second portion 10B to the first portion 10A.

As previously, this geometry makes it possible to minimise the quantity of energy necessary to allow the second arm 6 to retract at the passage of the movable element 20.

The radius r_10A of the first portion 10A of the profile 10 of the receiving surface 7 of the drive element 4 is between 6 and 14 mm.

Preferably, r_10A e is between 8 mm and 12 mm.

More preferably, the radius r_10A is between 9 mm and 11 mm.

In the example of FIG. 9, the first portion 10A of the profile 10 of the receiving surface 7 of the drive element 4 extends over an angular sector with an angular value of between 20° and 32°.

Preferably, the value of the angular sector is between 24° and 28°.

According to an embodiment, the radius r_10B of the second portion 10B of the profile 10 of the receiving surface 7 of the drive element 4 is between 60 mm and 100 mm.

Preferably, the radius r_10B is between 70 mm and 90 mm.

More preferably, the radius r_10B is between 78 mm and 82 mm.

The second portion 10B of the profile 10 of the receiving surface 7 of the drive element 4 extends over an angular sector with an angular value of between 7° and 9°.

The profile 10 of the receiving surface 7 of the drive element 4, seen in a direction parallel to the axis of rotation R6 of the second arm 6, also comprises a third portion 10C with a straight form, extending the second portion 10B in the form of an arc of a circle.

The third portion 10C of the profile 10 of the receiving surface 7 of the drive element 4, and the second portion 10B of the profile 10 of the receiving surface 7 of the drive element 4, are tangent at a second point of connection 10R2 of the third portion 10C to the second portion 10B.

The second portion 10B of the profile 10 of the receiving surface 7 of the drive element 4 extends around an angular sector of between 55° and 70°, preferably between 60° and 64°.

According to the example illustrated, the first end A7 of the receiving surface 7 of the drive element 4, forming an initial area of contact, forms part of the first portion 10A in the form of an arc of a circle of the drive element 4.

The second end B7 of the receiving surface 7 of the drive element 4, forming a final area of contact, forms part of the third portion 10C with a straight form of the drive element 4.

The profile 10 of the receiving surface 7 of the drive element 4, seen in a direction parallel to the axis of rotation R6 of the second arm 6, comprises a fourth portion 10D in the form of arc of a circle, extending the third portion 10C with a straight form.

As represented in FIG. 1, the support 12 comprises a first drive surface 14, and a second drive surface 14′. Each drive surface 14, 14′ is configured to be in contact with the receiving surface 7 of the drive element 4, during passage from the second position P2 to the first position P1.

The first drive surface 14 and the second drive surface 14′ are positioned on both sides of the movable element 20.

The drive element 4 comprises a first receiving surface and a second receiving surface 7′. The two receiving surfaces 7, 7′ are positioned on the second arm 6 of the drive element 4.

The first drive surface 14 cooperates with the first receiving surface 7, and the second drive surface 14′ cooperates with the second receiving surface 7′.

The two receiving surfaces 7, 7′ are in this case separated by a network of ribs, making it possible to strengthen the second arm 6. The two blades 11, 11′ are facing the network of ribs during the driving of the second arm 6.

1. A switching device for an electrical apparatus, the switching device comprising:
a vacuum interrupter comprising a first electrode and a second electrode which can be displaced displaceable between a closing position and an opening position;
a drive element mechanically connected to the second electrode;
a movable element displaceable between a first position permitting passage of electrical current in a main electrical circuit of the electrical apparatus, and a second position which prevents the passage of electrical current in the main electrical circuit,
the movable element comprising:
an electrically conducting blade;
a support secured to the electrically conducting blade,
wherein said movable element is configured to:
according to a first direction of displacement corresponding to passage from the first position to the second position, drive the drive element of the movable electrode via the conducting blade; and
according to a second direction of displacement, opposite the first direction of displacement, and corresponding to passage from the second position to the first position, drive the drive element of the movable electrode via the support,
wherein the support comprises a drive surface configured to be in contact with a receiving surface of the drive element during passage of the movable element from the second position to the first position,
and wherein:
the drive surface of the support has a curved shape; and
the receiving surface of the drive element has a curved shape.

2. The switching device according to claim 1, wherein the drive surface of the support and the receiving surface of the drive element are formed such that mechanical contact between the drive surface of the support and the receiving surface of the drive element is a linear contact.

3. The switching device according to claim 2, wherein the movable element is movable in rotation around an axis of rotation,
wherein the support extends parallel to the conducting blade, with a portion of the support forming a drive surface being positioned projecting from the blade, and
wherein a line of contact between the drive surface of the support and the receiving surface of the drive element extends in a direction parallel to the axis of rotation of the movable element.

4. The switching device according to claim 1, wherein the drive element comprises a first arm and a second arm which can pivot in relation to the first arm along an axis of pivoting,
wherein:
the first arm comprises a stop which is configured to block pivoting of the second arm in relation to the first arm in a first direction of rotation corresponding to passage of the movable element from the first position to the second position, such that the movable element drives the first arm via the second arm;
the second arm can pivot in relation to the first arm in a second direction of rotation corresponding to passage of the movable element from the second position to the first position;
and wherein the receiving surface of the drive element is formed on the second arm.

5. The switching device according to claim 4, wherein a distance between the line of contact of the drive surface of the support with the receiving surface of the drive element and the axis of pivoting of the second arm depends on an angular position of the movable element, and decreases in a monotonic manner as the angular position of the movable element approaches the first position.

6. The switching device according to claim 4, wherein:
the drive surface of the support extends between:
a first end forming an area of establishment of mechanical contact with the receiving surface of the drive element; and
a second end forming an area of loss of contact with the receiving surface of the drive element,
wherein the receiving surface of the drive element extends between:
a first end forming an area of establishment of mechanical contact with the support; and
a second end forming an area of loss of contact with the support, and wherein the first end of the receiving surface of the drive element is further away from the axis of pivoting of the second arm than the second end of the receiving surface of the drive element which forms a final area of contact.

7. The switching device according to claim 6, wherein the first end of the receiving surface of the drive element, forming an area of establishment of mechanical contact with the support, is facing an edge of the second arm.

8. The switching device according to claim 4, wherein a profile of the drive surface of the support and a profile of the receiving surface of the drive element are configured to orient a thrust force of the drive surface onto the second arm of the drive element, in a direction substantially perpendicular to a direction tangent to the second arm and the drive element.

9. The switching device according to claim 4, wherein the second arm of the drive element extends along a main axis, and wherein a drive force exerted by the support on the second arm of the drive element is oriented in a direction forming an angle of between 70° and 90° with the main axis of extension of the second arm of the drive element.

10. The switching device according to claim 4, wherein a profile of the drive surface of the support, seen in a direction parallel to the axis of pivoting of the second arm, comprises a first portion in the form of an arc of a circle, extended by a second portion in the form of an arc of a circle,
and wherein the first portion of the profile of the drive surface of the support and the second portion of the profile of the drive surface of the support are tangent at a point of connection of the first portion to the second portion.

11. The switching device according to the preceding claim 10, wherein a radius of the first portion of the profile of the drive surface of the support is between 8 and 16 mm, preferably between 10 mm and 14 mm, and more preferably between 11 mm and 13 mm,
and wherein the first portion of the profile of the drive surface of the support extends over an angular sector with a value of between 5° and 45°.

12. The switching device according to claim 10, wherein a radius of the second portion of the profile of the drive surface of the support is between 24 mm and 40 mm, preferably between 28 mm and 36 mm, and more preferably between 31 mm and 33 mm,
and wherein the second portion of the profile of the drive surface of the support extends over an angular sector with an angular value of between 30° and 90°.

13. The switching device according to claim 10,
wherein the drive surface of the support extends between:
a first end forming an area of establishment of mechanical contact with the receiving surface of the drive element; and
a second end forming an area of loss of contact with the receiving surface of the drive element,
wherein the receiving surface of the drive element extends between:
a first end forming an area of establishment of mechanical contact with the support; and
a second end forming an area of loss of contact with the support,
wherein the first end of the receiving surface of the drive element is further away from the axis of pivoting of the second arm than the second end of the receiving surface of the drive element which forms a final area of contact,
wherein the first end of the drive surface of the support, forming an area of establishment of mechanical contact with the receiving surface of the drive element, forms part of the first portion in the form of an arc of a circle, and
wherein the second end of the drive surface of the support, forming an area of loss of contact with the receiving surface of the drive element, forms part of the second portion in the form of an arc of a circle.

14. The switching device according to claim 4, wherein a profile of the receiving surface of the drive element, seen in a direction parallel to the axis of rotation of the second arm, comprises a first portion in the form of an arc of a circle, extended by a second portion in the form of an arc of a circle,
wherein the second portion of the profile of the receiving surface of the drive element, and the first portion of the profile of the receiving surface of the drive element are tangent at a first point of connection of the second portion to the first portion.

15. The switching device according to claim 14, wherein a radius of the first portion of the profile of the receiving surface of the drive element is between 6 and 14 mm, preferably between 8 mm and 12 mm, and more preferably between 9 mm and 11 mm,
wherein the first portion of the profile of the receiving surface of the drive element extends over an angular sector with an angular value of between 20° and 32°, preferably between 24° and 28°.

16. The switching device according to claim 14, wherein the second portion of the profile of the receiving surface of the drive element extends over an angular sector with an angular value of between 7° and 9°.

17. The switching device according to claim 14,
wherein the radius of the second portion of the profile of the receiving surface of the drive element is between 60 mm and 100 mm, preferably between 70 mm and 90 mm, and more preferably between 78 mm and 82 mm,
and wherein the second portion of the profile of the receiving surface of the drive element extends over an angular sector of between 55° and 70°, preferably between 60° and 64°.

18. The switching device according to claim 14,
wherein the drive surface of the support extends between:
a first end forming an area of establishment of mechanical contact with the receiving surface of the drive element; and
a second end forming an area of loss of contact with the receiving surface of the drive element,
wherein the receiving surface of the drive element extends between:
a first end forming an area of establishment of mechanical contact with the support; and
a second end forming an area of loss of contact with the support,
wherein the first end of the receiving surface of the drive element is further away from the axis of pivoting of the second arm than the second end of the receiving surface of the drive element which forms a final area of contact,
wherein the first end of the receiving surface of the drive element, forming an initial area of contact, forms part of the first portion in the form of an arc of a circle of the drive element,
and wherein the second end of the receiving surface of the drive element, forming a final area of contact, forms part of the third portion with a straight form of the drive element.

19. A medium voltage electrical apparatus, which is configured selectively to establish or cut off the current in a medium voltage electrical network comprising three phases, comprising an electrical current switching device according to one of the preceding claims, positioned respectively on each of the phases of the electrical network.
